(19) United States
(12) Patent Application Publication
(10) Pub. No.: US 2013/0146090 A1
(43) Pub. Date: Jun. 13, 2013

(54) METHOD FOR CONTROLLING AUTOMATIC CLEANING DEVICES

(71) Applicant: Joseph Y. KO, (US)

(72) Inventor: Joseph Y. KO, (US)

(21) Appl. No.: 13/324,300

(22) Filed: Dec. 13, 2011

(51) Int. Cl. B08B 7/04

(52) U.S. Cl. 134/18

(57) ABSTRACT

A method for controlling an automatic cleaning device includes the steps of: entering selectively a regular control signal or a power-saving control signal to a cleaning mode control unit; judging whether the regular control signal or power-saving control signal is received to allow the cleaning mode control unit to enter a corresponding regular cleaning mode or a power-saving cleaning mode; activating a first driving motor and a second driving motor in the regular cleaning mode to allow the automatic cleaning device to move on an automatic movement path and keep a cleaning device in operation and pull a passive cleaning device; or activating the second driving motor by the cleaning mode control unit in the power-saving cleaning mode to allow the automatic cleaning device to move on the automatic movement path and pull the passive cleaning device.

### FIELD OF THE INVENTION

The present invention relates to an automatic cleaning device and particularly to a method for controlling automatic cleaning devices.

### BACKGROUND OF THE INVENTION

In earlier days the chore of cleaning floor usually relies on brooms and mops, and a lot of physical labor and time are needed. Moreover, small dirt on the floor usually cannot be removed or cleared thoroughly. With the invention of dust collectors, they are driven by an electric motor, thus the dirt on the floor can be cleared thoroughly. However, the conventional dust collector cannot move automatically, and has to rely on users to determine the cleaning area and move the dust collector to clean the intended area.

Now automatic dust collector has been developed and marketed. It does not need manual control. Once activated it can automatically perform cleaning operation and move around according to a set program to clear dirt in an intended area. For instance, U.S. publication No. 2010/0287717 discloses an automatic cleaning device equipped with a cleaning brush. It includes a body and a rotary brush held in the body. The brush includes a plurality of first brush cleaning units to pick up targeted objects and a second brush cleaning unit to sweep off the small dirt such as dust or hairs attached to the first brush cleaning unit. It even can detect and dodge obstacles and move intelligently. Another U.S. publication No. 2010/0313364 discloses a robot cleaner and method of controlling the same with an improved moving mode. The robot cleaner can move in a zigzag fashion to perform basic cleaning, and then move randomly to finish cleaning process by skipping the area already covered by the zigzag movement. When encountering a wall the robot cleaner moves in the zigzag fashion in a designated interval against the wall. In the event that the robot cleaner detects an obstacle during the zigzag movement, it adopts an improved zigzag fashion to keep moving.

Some automatic dust collectors even are equipped with wiping function by adding a mop portion to mop the floor during moving. But they generally do not provide separated control of movement and dust collection, i.e., when the movement function is activated the dust collecting function also is activated at the same time. Hence they do not provide floor mopping function independently. As a result usability suffers, and more electric power consumption occurs. Users have to charge or change batteries frequently. There are still rooms for improvement.

### SUMMARY OF THE INVENTION

The primary object of the present invention is to solve the problem of conventional dust collectors that cannot be used and moved independently and consume a lot of unnecessary electric power.

To achieve the foregoing object, the present invention provides a method for controlling automatic cleaning devices. The automatic cleaning device includes a passive cleaning device in contact with a floor, a cleaning device, a first driving motor to drive the cleaning device operating, a wheel and a second driving motor to drive the wheel and the automatic cleaning device moving on an automatic movement path. The method of the invention includes the steps as follows:

selectively entering a regular control signal or a power-saving control signal to a cleaning mode control unit which is electrically connected to the first driving motor and second driving motor;

judging whether the regular control signal or power-saving control signal is received to allow the cleaning mode control unit to enter a corresponding regular cleaning mode or a power-saving cleaning mode; and

activating the first and second driving motors by the cleaning mode control unit in the regular cleaning mode to allow the automatic cleaning device to move on the automatic movement path and keep the cleaning device in operation and pull the passive cleaning device; or activating the second driving motor by the cleaning mode control unit in the power-saving cleaning mode to allow the automatic cleaning device to move on the automatic movement path and merely pull the passive cleaning device.

In one aspect, the invention further includes steps as follows:

entering a shut-down signal to the cleaning mode control unit;

setting the cleaning mode control unit to enter a shut-down mode according to the shut-down signal; and

setting the cleaning mode control unit to shut down the first and second driving motors in the shut-down mode to stop the automatic cleaning device operating.

In another aspect, the invention further includes a step of pressing a switch located on the automatic cleaning device to generate the regular control signal or power-saving control signal; the switch is electrically connected to the cleaning mode control unit.

In yet another aspect, the regular control signal is generated by pressing the switch once.

In yet another aspect, the power-saving control signal is generated by pressing the switch continuously.

In yet another aspect, the step of entering the shut-down signal is to enter the shut-down signal to the cleaning mode control unit by pressing the switch for a long duration.

In yet another aspect, the invention further includes a step of operating a remote control unit to generate the regular control signal or power-saving control signal; the automatic cleaning device receives the regular control signal or power-saving control signal from the remote control unit.

In yet another aspect, the step of entering the shut-down signal is to enter the shut-down signal the cleaning mode control unit through the remote control unit.

The invention thus formed provides many advantages, notably:

The automatic cleaning device divides cleaning mode into the regular cleaning mode and power-saving cleaning mode. Users can activate the regular cleaning mode while cleaning the floor is desired, and then the first and second driving motors are activated at the same time to allow the automatic cleaning device to move on the automatic movement path and keep the cleaning device in operation and also pull the passive cleaning device to clear dirt on the floor and mop the floor at the same time. In the event that merely mopping the floor is desired to maintain floor clean, the power-saving cleaning mode is activated to activate merely the second driving motor so that only the passive cleaning device is pulled while the automatic cleaning device moves on the automatic movement path, and the power to drive the first driving motor can be saved. Therefore, users can employ the automatic cleaning device according to different requirements to efficiently use electric power thereof without always activating two motors at the same time when in use that might otherwise accelerate power consumption and cause frequent charge problem.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a top perspective view of the automatic cleaning device employed in the method of the invention.

FIG. 2 is a bottom perspective view of the automatic cleaning device employed in the method of the invention.

FIG. 3 is a structural block diagram of the automatic cleaning device employed in the method of the invention.

FIG. 4 is a flowchart of a first embodiment of the method of the invention.

FIG. 5 is a flowchart of a second embodiment of the method of the invention.

### DETAILED DESCRIPTION OF THE PREFERRED EMBODIMENTS

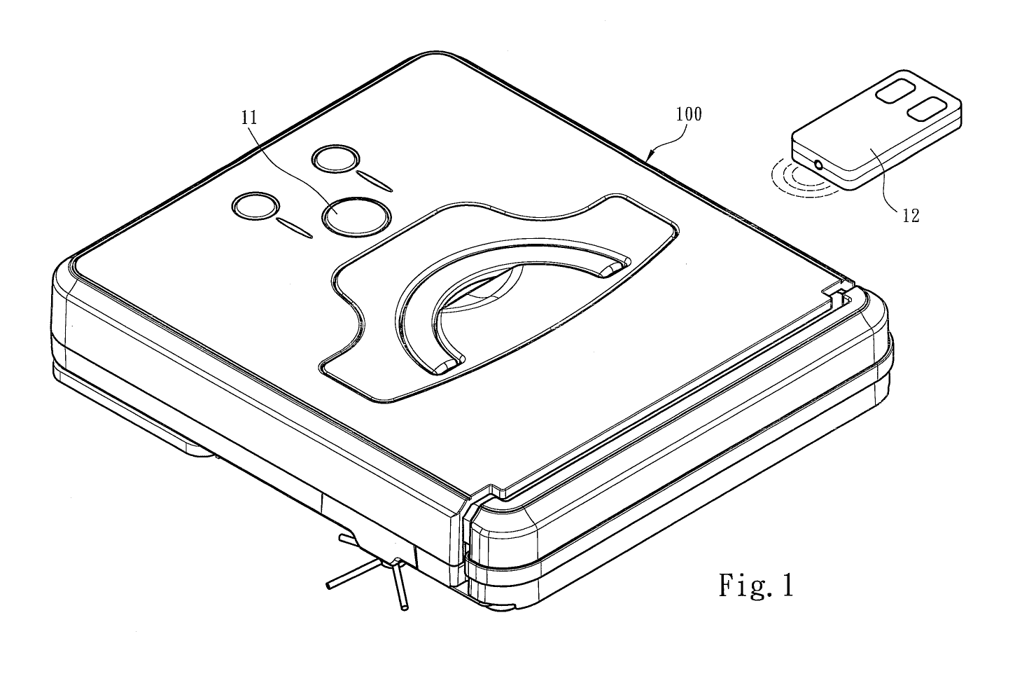

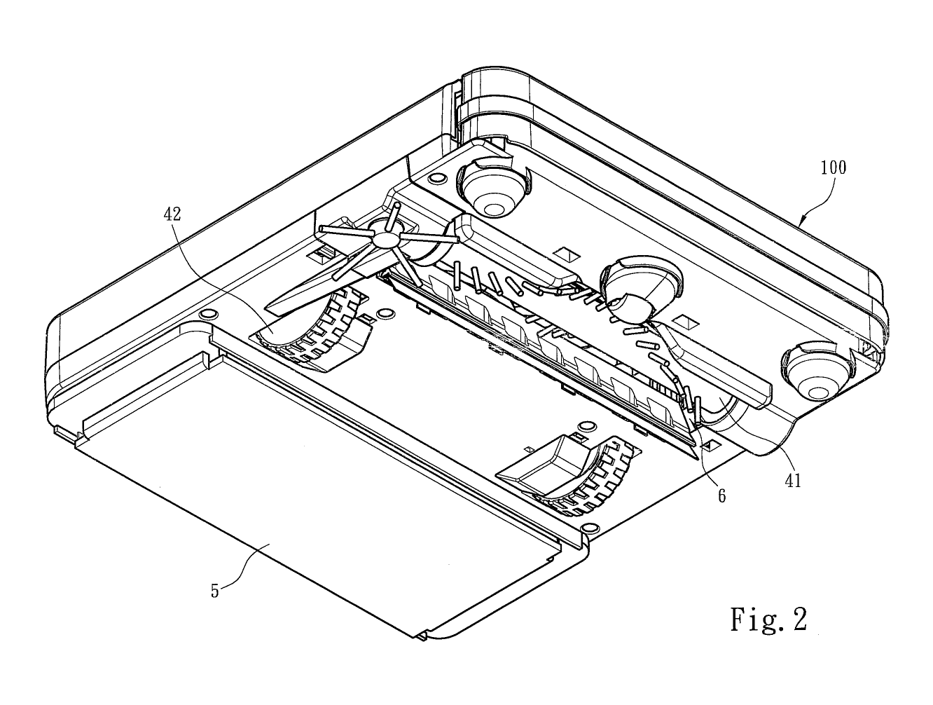

Please refer to FIGS. 1, 2 and 3, the present invention aims to provide a method for controlling an automatic cleaning device 100 which includes a passive cleaning device 5 in contact with a floor, a cleaning device 41, a first driving motor 31 to drive the cleaning device 41 operating, a wheel 42 and a second driving motor 32 to drive the wheel 42 and the automatic cleaning device 100 moving on an automatic movement path. The cleaning device 41 may be a rotary brush, a dust suction device, a dust suction device equipped with a rotary brush or an ultraviolet bactericidal lamp. In this embodiment, the cleaning device 41 is a rotary brush. The automatic cleaning device 100 further has a switch 11 or a remote control unit 12 to receive signals therefrom, and a dust collection vent 6 located near the rotary brush 41. The dust collection vent 6 communicates with the interior of the automatic cleaning device 100. The rotary brush 41 sweeps dirt to pass through the dust collection vent 6 and deposit in the automatic cleaning device 100. A user can press the switch 11 or use the remote control unit 12 to output a control signal to drive the automatic cleaning device 100 to do cleaning operation.

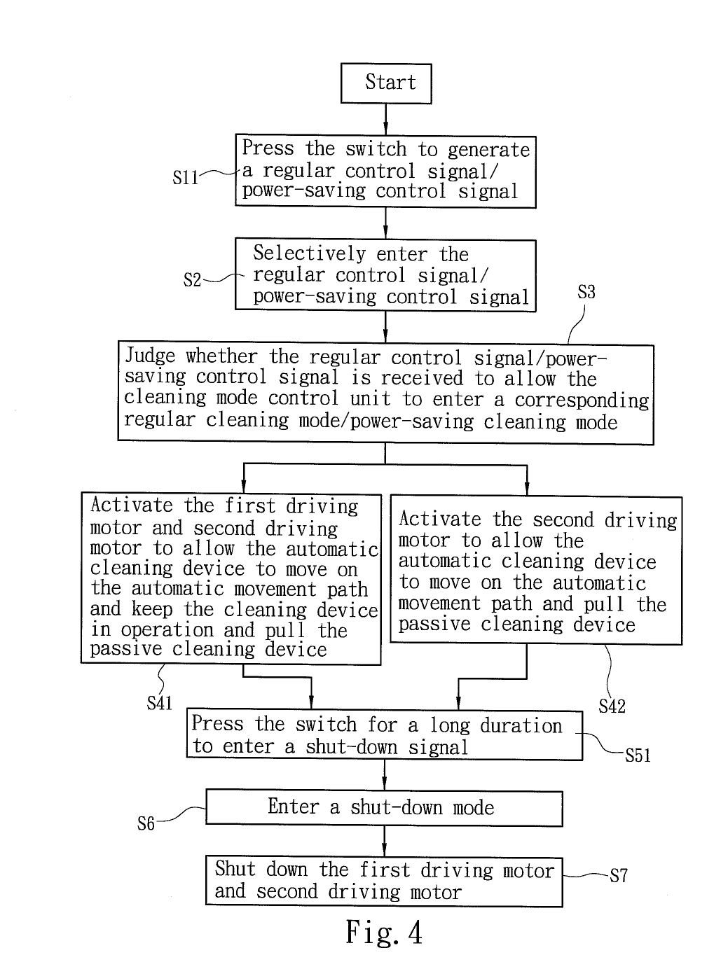

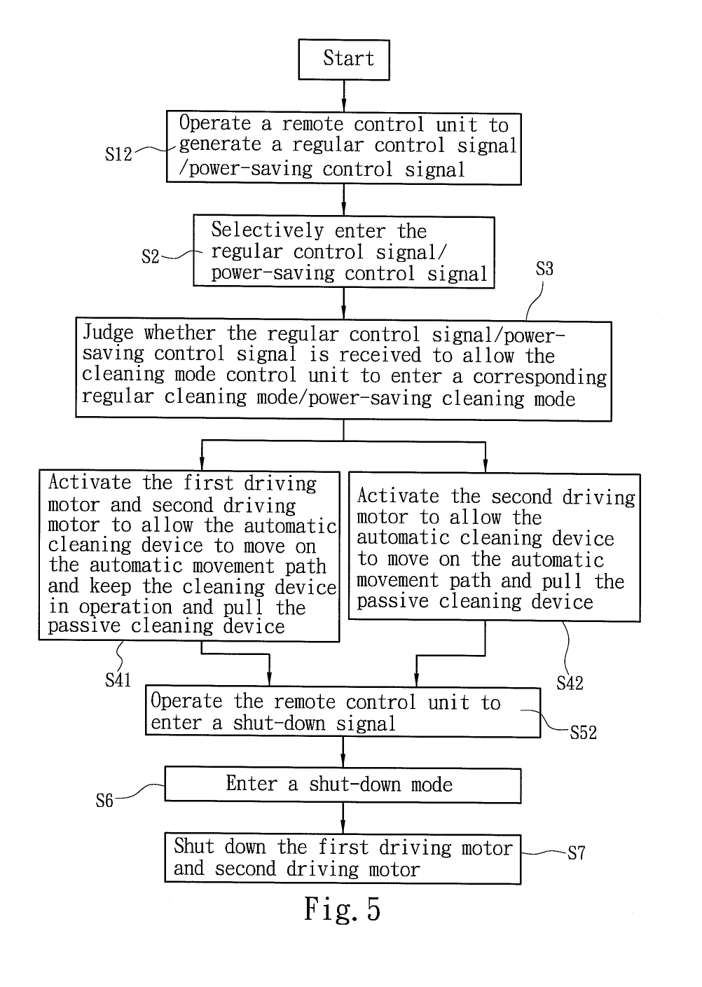

Please refer to FIGS. 4 and 5 for the method of the invention. It comprises the steps as follows: first, selectively entering a regular control signal or a power-saving control signal to a cleaning mode control unit 2 (S2) which is electrically connected to the first driving motor 31 and the second driving motor 32; next, judging by the cleaning mode control unit 2 the receiving of the regular control signal to enter a regular cleaning mode, or the receiving of the power-saving control signal to enter a power-saving cleaning mode (S3); in the regular cleaning mode, the cleaning mode control unit 2 activates the first driving motor 31 to drive the cleaning device 41 and activates the second driving motor 32 to drive the wheel 42 so that the automatic cleaning device 100 moves on the automatic movement path and keeps the cleaning device 41 in operation and also pulls the passive cleaning device 5 (S41); or in the power-saving cleaning mode, the cleaning mode control unit 2 activates the second driving motor 32 to allow the automatic cleaning device 100 to move on the automatic movement path and pull merely the passive cleaning device 5 (S42).

After the cleaning operation is finished, entering a shut-down signal to the cleaning mode control unit 2 (S51, S52). Based on the shut-down signal, the cleaning mode control unit 2 enters a shut-down mode (S6); finally, in the shut-down mode, the cleaning mode control unit 2 shuts down the first driving motor 31 and second driving motor 32 to stop the automatic cleaning device 100 operating (S7). The passive cleaning device 5 can be a wiper, a scouring pad, a vegetable sponge of luffa, a fiber wiper, a dust-collecting paper or a material capable of sucking dust.

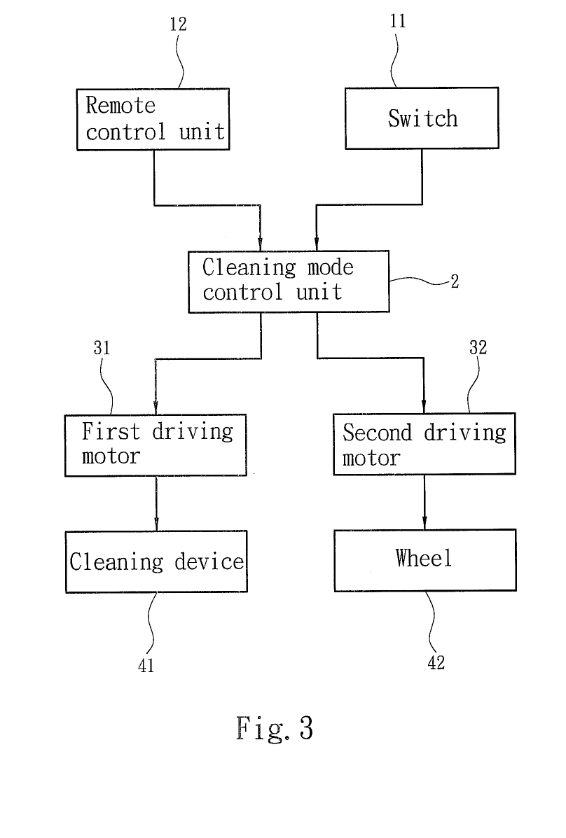

Please referring to FIGS. 3 and 4, in a first embodiment of the invention the automatic cleaning device 100 includes a switch 11 to generate and output the regular control signal or power-saving control signal; the switch 11 is electrically connected to the cleaning mode control unit 2. When performing cleaning operation is desired, first, pressing the switch 11 located on the automatic cleaning device 100 to generate the regular control signal or power-saving control signal (S11), wherein user can selectively press the switch 11 once to generate the regular control signal (S11) and send the regular control signal to the cleaning mode control unit 2 (S2), or pressing continuously the switch 11 to generate the power-saving control signal and send the power-saving control signal to the cleaning mode control unit 2 (S2); then judging by the cleaning mode control unit 2 the receiving of the regular control signal to enter the regular cleaning mode, or the receiving of the power-saving control signal to enter the power-saving cleaning mode (S3). In the event that the regular cleaning mode is activated, the cleaning mode control unit 2 activates the first driving motor 31 to drive the cleaning device 41 operating and activates the second driving motor 32 to drive the wheel 42 so that the automatic cleaning device 100 moves on the automatic movement path and keeps the cleaning device 41 in operation to clear dirt on the floor, and also pulls the passive cleaning device 5 to mop the floor (S41). In the event that the power-saving cleaning mode is activated, the cleaning mode control unit 2 activates the second driving motor 32 to drive the wheel 42 so that the automatic cleaning device 100 moves on the automatic movement path and merely pulls the passive cleaning device 5 to mop the floor (S42). After the cleaning operation is finished, the switch can be pressed for at least 0.5 second to output the shut-down signal (S51), and then the cleaning mode control unit 2 enters the shut-down mode according to the shut-down signal (S6); finally, in the shut-down mode, the cleaning mode control unit 2 shuts down the first and second driving motors 31 and 32 to stop the automatic cleaning device 100 operating (S7), thus is finished one cycle of automatic cleaning operation.

Please refer to FIGS. 3 and 5 for another embodiment of the invention. The automatic cleaning device 100 includes a remote control unit 12 to generate the regular control signal or power-saving control signal for outputting. During cleaning operation, first, operating the remote control unit 12 to generate the regular control signal or power-saving control signal (S12); next, judging by the cleaning mode control unit 2 the receiving of the regular control signal to enter a regular cleaning mode, or the receiving of the power-saving control signal to enter a power-saving cleaning mode (S3); in the regular cleaning mode, the cleaning mode control unit 2 activates the first driving motor 31 to drive the cleaning device 41 operating and activates the second driving motor 32 to drive the wheel 42 so that the automatic cleaning device 100 moves on the automatic movement path and keeps the cleaning device 41 in operation to clear the dirt on the floor and also pulls the passive cleaning device 5 to mop the floor (S41); in the power-saving cleaning mode, the cleaning mode control unit 2 activates the second driving motor 32 to drive the wheel 42 so that the automatic cleaning device 100 moves on the automatic movement path and pulls merely the passive cleaning device 5 to mop the floor (S42). After the cleaning operation is finished, user can use the remote control unit to output the shut-down signal (S52) so that the cleaning mode control unit 2 enters a shut-down mode according to the shut-down signal (S6); finally, in the shut-down mode, the cleaning mode control unit 2 shuts down the first and second driving motors 31 and 32 to stop the automatic cleaning device 100 operating (S7), thus is finished one cycle of automatic cleaning operation.

As a conclusion, the automatic cleaning device 100 of the invention has the cleaning mode divided into a regular cleaning mode and a power-saving cleaning mode. When cleaning the floor is desired, the regular cleaning mode is activated to activate the first driving motor 31 and second driving motor 32 at the same time so that the automatic cleaning device 100 moves on the automatic movement path and keeps the cleaning device 41 in operation and also pulls the passive cleaning device 5 to clear the dirt on the floor and mop the floor at the same time. In the event that merely mopping the floor to maintain clean is desired, the power-saving cleaning mode is activated to activate only the second driving motor 32 so that the automatic cleaning device 100 moves on the automatic movement path and pulls only the passive cleaning device 5 without activating the first driving motor 31, thus can save electric power consumed by the first driving motor 31. As a result, users can employ the automatic cleaning device 100 according to different requirements to efficiently use electric power without activating two motors at the same time when in use, thereby power consumption can be reduced and frequent charge problem can be averted.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for controlling an automatic cleaning device which includes a passive cleaning device in contact with a floor, a cleaning device, a first driving motor to drive the cleaning device operating and a second driving motor to drive the automatic cleaning device moving on an automatic movement path, the method comprising the steps of:
entering selectively a regular control signal or a power-saving control signal to a cleaning mode control unit which is electrically connected to the first driving motor and the second driving motor;
judging whether the regular control signal or the power-saving control signal is received to allow the cleaning mode control unit to enter a regular cleaning mode or a power-saving cleaning mode; and
activating the first driving motor and the second driving motor by the cleaning mode control unit in the regular cleaning mode to allow the automatic cleaning device to move on the automatic movement path and keep the cleaning device in operation and pull the passive cleaning device; or activating the second driving motor by the cleaning mode control unit in the power-saving cleaning mode to allow the automatic cleaning device to move on the automatic movement path and pull the passive cleaning device.

2. The method of claim 1 further including the steps of:
entering a shut-down signal to the cleaning mode control unit;
setting the cleaning mode control unit to enter a shut-down mode according to the shut-down signal; and
setting the cleaning mode control unit to shut down the first driving motor and the second driving motor in the shut-down mode to stop the automatic cleaning device operating.

3. The method of claim 2 further including a step of pressing a switch located on the automatic cleaning device to generate the regular control signal or the power-saving control signal, the switch being electrically connected to the cleaning mode control unit.

4. The method of claim 3, wherein the step of entering the shut-down signal is to enter the shut-down signal to the cleaning mode control unit by pressing the switch for a long duration.

5. The method of claim 2 further including a step of operating a remote control unit to generate the regular control signal or the power-saving control signal, the automatic cleaning device receiving the regular control signal or the power-saving control signal from the remote control unit.

6. The method of claim 5, wherein the step of entering the shut-down signal is to enter the shut-down to the cleaning mode control unit via the remote control unit.

7. The method of claim 1 further including a step of pressing a switch located on the automatic cleaning device to generate the regular control signal or the power-saving control signal, the switch being electrically connected to the cleaning mode control unit.

8. The method of claim 7, wherein the regular control signal is generated by pressing the switch once.

9. The method of claim 7, wherein the power-saving control signal is generated by pressing the switch continuously.

10. The method of claim 1 further including a step of operating a remote control unit to generate the regular control signal or the power-saving control signal, the automatic cleaning device receiving the regular control signal or the power-saving control signal from the remote control unit.
